(19) United States
(12) Patent Application Publication
(10) Pub. No.: US 2018/0120812 A1
(43) Pub. Date: May 3, 2018

(54) Configurable Product Housing System

(71) Applicant: Wal-Mart Stores, Inc., Bentonville, AR (US)

(72) Inventors: Robert James Taylor, Rogers, AR (US); Jeffrey Scott Cruz, Bentonville, AR (US); Jamison Lonnie Kyle Sibley, Rogers, AR (US); Leigh Ann Marie Scobey, Bentonville, AR (US); Timothy Scott Eller, Bentonville, AR (US)

(21) Appl. No.: 15/796,404

(22) Filed: Oct. 27, 2017

Related U.S. Application Data
(60) Provisional application No. 62/416,918, filed on Nov. 3, 2016.

(51) Int. Cl. G05B 19/406; G06F 17/30; G05B 19/402

(52) U.S. Cl. CPC G05B 19/406; G06Q 10/083; G05B 19/402; G06F 17/30979

(57) ABSTRACT

Systems and methods for a configurable product housing are described. A reconfigurable product housing is mechanically coupled to an adjustment mechanism and communicatively coupled to a computing device thereby enabling adjustment of a volume of an interior cavity of the product housing.

### CROSS-REFERENCE TO RELATED PATENT APPLICATIONS

This application claims priority to U.S. Provisional Application No. 62/416,918 filed on Nov. 3, 2016, the content of which is hereby incorporated by reference in its entirety.

### BACKGROUND

Supply chains attempt to identify a correct amount of physical objects to provide to a facility. The physical objects once delivered may be presented for viewing within the facility.

### BRIEF SUMMARY

In one embodiment, a configurable product housing system includes a housing equipped with a processing device and further includes a back wall, opposing side walls, and a base defining an interior cavity accessible via an open front face of the housing. The housing is configured to store physical objects within the interior cavity. The included processing device includes a processor a communication capability. The system further includes a backer positioned in front of the back wall in the interior cavity, the backer extending from the base. The system also includes an adjustment system mechanically coupled to the backer and configured to adjust a position of the backer within the interior cavity. The adjustment mechanism is controllable by the included processing device. The system further includes a database holding information about the physical objects and also includes a computing device in communication with the database and the included processing device. The computing device is configured to query the database to retrieve a set of attributes associated with the physical objects, calculate a quantity of physical objects to be loaded into the interior cavity of the housing based on the set of attributes, transmit a command to the included processing device to adjust the position of the backer within the interior cavity based on the calculated quantity of physical objects. The calculated quantity of physical objects is then loaded into the interior cavity of the housing.

In one embodiment a loading method for a configurable product housing, the method includes, providing a housing equipped with an included processing device and further including a back wall, opposing side walls, and a base defining an interior cavity accessible via an open front face of the housing. The housing further includes a backer extending from the base and positioned in front of the back wall in the interior cavity. The included processing device includes a processor and a communication capability. The backer is configured to be adjustable within the interior cavity. The method further includes, querying, via a computing device in communication with the included processing device, a database to retrieve a set of attributes associated with physical objects. The method further includes, calculating, with the computing device, a quantity of the plurality of physical objects to be loaded into the interior cavity of the housing based on the set of attributes. The method also includes transmitting a command to the included processing device to adjust the position of the backer based on the calculated quantity of physical objects. The position of the backer is adjusted by an adjustment mechanism controlled by the included processing device and the calculated quantity of physical objects is loaded into the interior cavity of the housing.

In one embodiment, a configurable product housing system includes a housing equipped with an included processing device and disposed in a shelving unit located in a facility, the housing further including a top wall, an adjustable back wall, opposing side walls, and a base defining an interior cavity accessible via an open front face of the housing. The interior cavity is configured to store physical objects. The system also includes an adjustment mechanism mechanically coupled to the adjustable back wall and configured to adjust a position of the back wall within the housing. The adjustment mechanism is controllable by the included processing device. The system further includes a database holding information about the physical objects and a computing device equipped with a processor, The computing device is in communication with the included processing device and a database and is configured to query the database to retrieve a set of attributes associated with the physical objects. The computing device is also configured to calculate a quantity of physical objects to be loaded into the interior cavity of the housing based on the set of attributes and to transmit a command to the included processing device to adjust the position of the adjustable back wall within the housing based on the calculated quantity of physical objects. The calculated quantity of physical objects is then loaded into the interior cavity of the housing.

### BRIEF DESCRIPTION OF DRAWINGS

To assist those of skill in the art in making and using the described configurable product housing systems and associated methods, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting. In the figures:

FIG. 1A illustrates exemplary configurable product housings according to exemplary embodiments;

FIG. 1B illustrates the inside of a configurable product housing for storing objects in an exemplary embodiment;

FIG. 1C illustrates a side view of the product housing for storing objects in an exemplary embodiment;

FIG. 1D illustrates exemplary images displayed with respect to a configurable product housing according to exemplary embodiments

FIG. 1E illustrates exemplary images displayed with respect to a configurable product housing according to exemplary embodiments;

FIG. 2 illustrates an exemplary network environment of a configurable product housing system, in accordance with an exemplary embodiment;

FIG. 3 illustrates an exemplary computing system suitable for use in accordance with an exemplary embodiment; and

FIG. 4 is a flowchart illustrating an exemplary process implemented by a configurable product housing system according to an exemplary embodiment.

### DETAILED DESCRIPTION

Described in detail herein are methods and systems for loading objects in a configurable product housing. Exemplary embodiments include a system that provides a housing including a back wall, opposing side walls, optionally a top wall and a base defining an interior cavity accessible via an open front face of the housing. The housing further includes a backer extending from the base and positioned in front of the back wall in the interior cavity. The backer position is adjustable within the interior cavity. A computing device communicatively coupled to the housing queries a database to retrieve a set of attributes associated with a group of physical objects and calculates a quantity of the physical objects to be loaded into the interior cavity of the housing based on the attributes. A command is sent by the computing device to an included processing device in the housing to adjust the backer position based on the calculated quantity. The included processing device controls an adjustment mechanism connected to the backer to adjust the position of the backer based on the calculated quantity of physical objects. The calculated quantity of physical objects is then loaded into the interior cavity of the housing.

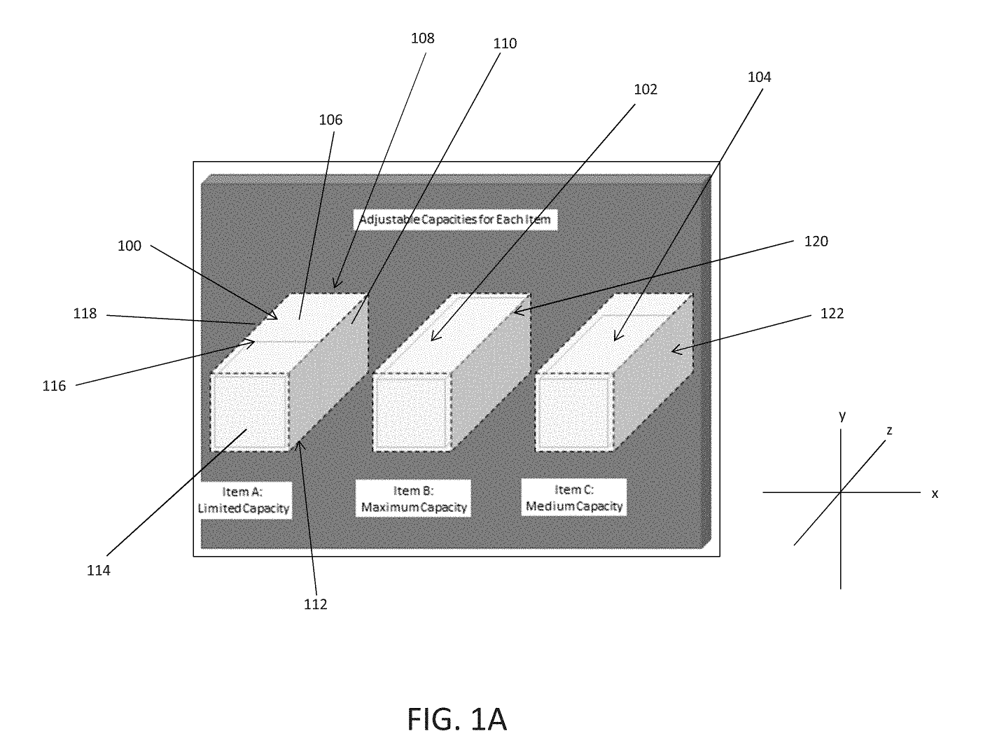

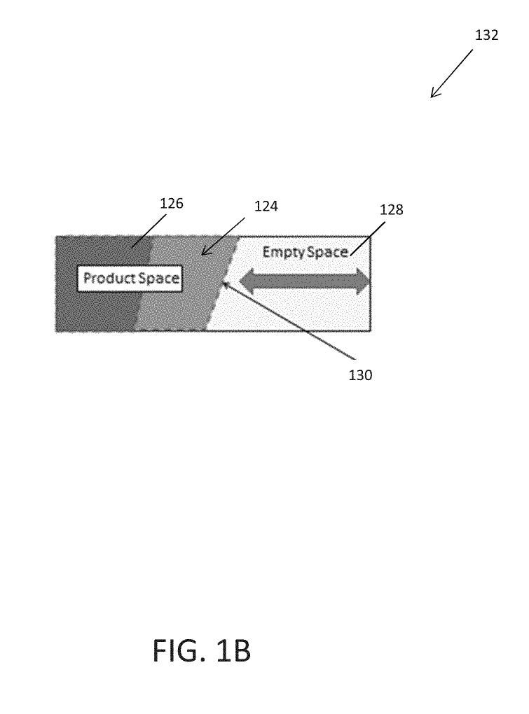

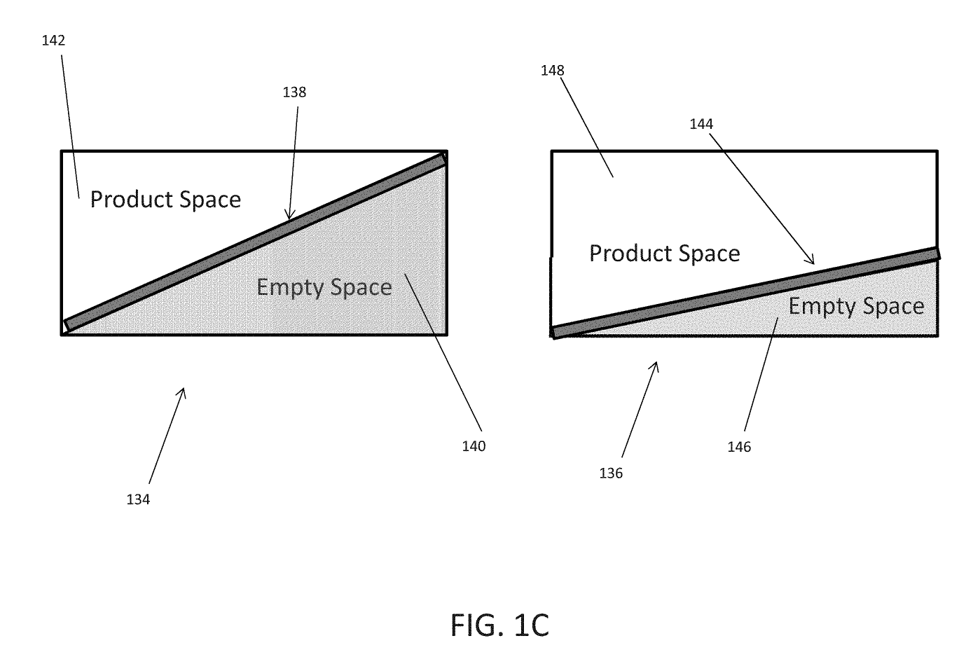

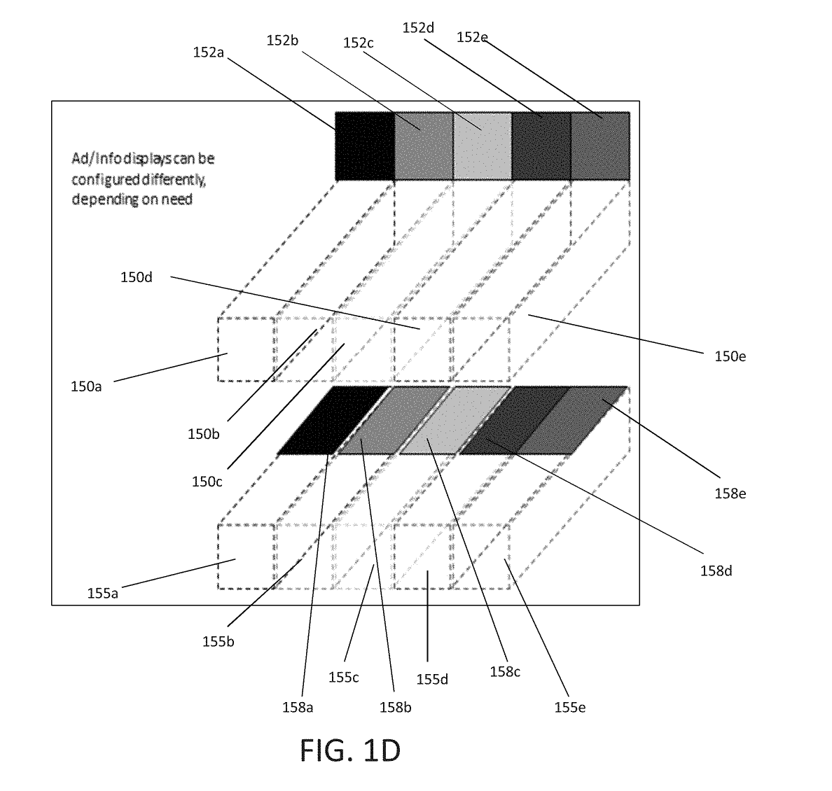

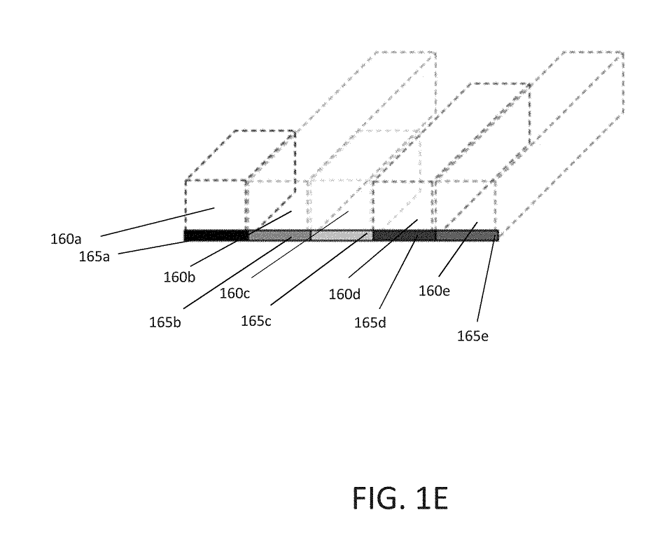

FIG. 1A illustrates exemplary configurable housings according to exemplary embodiments. In exemplary embodiments, configurable product housings 100-104 can be configured to store different amounts of physical objects. The configurable product housings 100-104 can include a back wall 108, opposing sidewalls 110, 118, a base 112, an optional top wall 106 and an open front face 114. The top wall 106 and base 112 can extend along the z-axis, parallel to one another. The opposing sidewalls 110 and 118 can extend perpendicularly, along the z-axis, from the top wall 106 and/or the base 112. The back wall 108 can extend perpendicularly, along the y-axis, from the top wall 106 and/or the base 112. The back wall 108, opposing side walls 110, 118, the base 108 and top wall 16 can help to define an interior cavity. The open front face 114 can provide access to the physical objects disposed within the interior cavity. The configurable product housings 100-104 can be configured to be secured to a storage unit. For example, the base 112 can be configured to be latched, fastened, clasped and/or bolted to a shelving unit. The configurable product housings 100-104 can also be removable from the shelving units. In one embodiment, the shelving unit may provide the top wall that helps to define the interior cavity for the configurable product housings.

Physical objects can be disposed within the interior cavity of the configurable product housings 100-104. The exterior dimensions of the configurable product housings 100-104 can be the same size while the available space in the interior cavity of the configurable product housings 100-104 can vary. The amount of physical objects disposed in the interior cavity can be limited by a backer (not shown) disposed within the interior cavity. For example, the housing 100 can have a limited capacity to store physical objects disposed from the open front face 114 to the end 116. The housing 102 can have a maximum capacity to store physical objects disposed from the open front face 114 to the end 120. Likewise the housing 104 can have a medium capacity to store physical objects disposed from the open front face 114 to the end 122. In one embodiment, the backer may be an adjustable back wall.

FIG. 1B illustrates the inside of a configurable product housing for storing objects in an exemplary embodiment. A configurable housing 132 can include an interior cavity 124 to store physical objects. The interior cavity 124 can include empty space 128 and product space 126. The physical objects can be stored within the product space 126. The housing 100 can also include a backer 130, positioned between and dividing the product space 126 from the empty space 128. The backer 130 can extend from the base of the housing to the top of the housing 132. The backer 130 can also be disposed at an angle within the interior cavity 124 and the position of the backer 130 can be adjusted by sliding the backer 108 along the interior cavity 124. Alternatively the backer may be located in an upright position. In some embodiments, the backer 130 can be coupled to a motor controlled by a processing device. The processing device which includes a processor and a wired and/or wireless communication capability can instruct the motor to adjust the position of the backer 130 forward and backward along the interior cavity 124 of the housing 132 based on analyzed criteria as described further herein. In one embodiment, tracks (not shown) can be disposed on the base of the interior cavity 124 and the backer 130 can be disposed on the tracks. The backer 130 can slide along the tracks.

The backer 130 functions to restrict access to the empty space 128 of the interior cavity 124. For example, physical objects can be disposed in the product space 126 of the interior cavity 124 but not in the empty space between the backer 130 and the back wall of the housing 132. The volume of the interior cavity 124 can be perceived as extending from the front face of the housing to the backer 130. The relative amounts of capacity of the of product space 126 and empty space 128 can be adjusted by adjusting the position of the backer 130 along the interior cavity. The backer 130 can limit the amount of physical objects disposed in the interior cavity 106. In some embodiments, the physical objects disposed within the interior cavity 124 can be perishable items. Accordingly, the interior cavity 124 can be temperature controlled. In one exemplary embodiment, the backer 130 is also the back wall of the housing 132 as opposed to being a separate component located within the housing.

FIG. 1C illustrates a side view of the product housing for storing objects in an exemplary embodiment. As discussed above, the backer 138, 144 of the housing 134, 136 restricts the access between the product space 142, 148 and empty space 140,146 and the backer 134, 136 can be adjusted by sliding the backer 138, 144 along the interior volume of the housing 134, 136. By adjusting the backer 138, 144, the volume for storing objects in the housing 134, 136 can change. For example, the housing 134 includes a backer 138 which restricts space between the product space 142 and the empty space 138. The backer 144 can slide (and/or tilt) downward inside the interior volume of the housing 136 to create more product space 148 and reduce the empty space 146. As mentioned above, the backer 138, 144 can alternatively, or additionally, be configured to slide forward and backward within the interior volume of the housing 136.

FIGS. 1D-E illustrate exemplary images displayed with respect to the configurable product housing according to exemplary embodiments. In exemplary embodiments, images 152a-e can be displayed above the housings 150a-e. For example, an image 152a can be disposed over housing 150a, an image 152b can be disposed over housing 150b, an image 152c can be disposed over housing 150c, an image 152d can be disposed over housing 150d and an image 152e can be disposed over housing 150e. The images 152a-e can display information associated with the physical objects disposed in the interior cavity of the housings 150a-e. For example, the images may be pictures of the product or information associated with the loaded product. Alternatively, the images 152a-e can display information not associated with the physical objects disposed in the interior cavity of the housings 150a-e.

In another embodiments, images 158a-e can be displayed on the top walls of the housings 155a-e. The images 158a-e can be configurable so that the images 158a-e extend from the backer to the back wall covering the empty space portion of the interior cavity from the top. The size of the images 158a-e can be adjusted based on the amount of physical objects within the interior cavity of the housings 150a-e. Turning our attention to FIG. 1E, the images 165a-e can be disposed beneath the front face of the housings 160a-e.

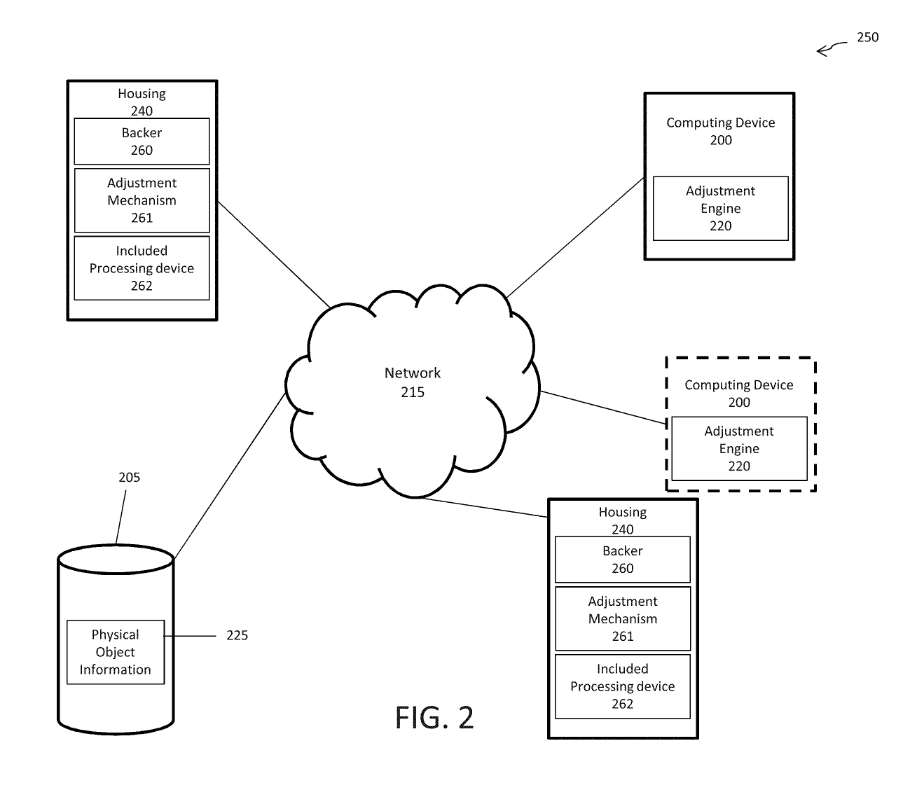

FIG. 2 illustrates an exemplary network environment for a configurable product housing system in an exemplary embodiment. The configurable product housing system 250 can include one or more databases 205, one or more computing devices 200 and one or more housings 240. In exemplary embodiments, the computing device 200 is in communication with the databases 205, and the included processing device 262 in the housing 240 via a communications network 215. The computing device 200 can execute at least one instance of an adjustment engine 220. In one embodiment, the adjustment engine 220 may query the database 205 for physical object information 225 such as a set of attributes related to the physical objects. Based on the results of the query, the adjustment engine 220 may calculate a quantity of physical objects to be loaded into the interior cavity of the housing. Following the calculation, the computing device 200 may transmit a command to the included processing device 262 to adjust the position of the backer to accommodate the calculated quantity of physical objects in the housing 240. The command may be received by the included processing device 262 which in turn may command the attachment mechanism 261 to adjust the position of the backer 260. For example, in one embodiment the included processing device 262 may be a system on a chip equipped with a processor that has the ability to control a motor connected to the backer so as to move the backer position within the housing based on the command.

In an example embodiment, one or more portions of the communications network 215, can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing device 200 and the databases 205 are connected to the communications network 215 via a wired or wireless connection. The computing device 200 includes one or more processors configured to communicate with the housing 240 and the databases 205, via the network 215. The computing device 200 hosts one or more applications configured to interact with one or more components of the configurable product housing system and/or facilitates access to the content of the databases 205. The databases 205 may store information/data, as described herein. For example, the databases 205 can include a physical objects database 225. The physical objects database 225 can store information associated with physical objects. The databases 205 and computing device 200 can be located at one or more geographically distributed locations from each other. Alternatively, the databases 205 can be included within computing device 200.

In exemplary embodiments, a fulfillment of a set of like physical objects can be needed at a facility. A computing device 200 receives a request to determine a quantity of physical objects to load into a housing 240, for delivery to the facility. The request can include an identifier associated with the physical objects. The computing device 200 an execute the adjustment engine 220 in response to receiving the request. The adjustment engine 220 can query the physical objects database 225 using the identifier to retrieve a set of attributes associated with the physical objects. The set of attributes can include, a shape of a physical object, a size of a physical object, and a quantity of physical objects sent to the facility in the past. In some embodiments, the physical objects can be perishable items. Accordingly, the set of attributes can include, the amount of time the perishable items remain fresh, an ideal temperature for the perishable items and any other environmental condition-related attributes. The adjustment engine 220 can determine the quantity of physical objects which need to be loaded into the housing 240 based on the retrieved data and the amount of space available in the requesting housing. The adjustment engine 220 can adjust the position of the backer, by instructing the included processing device 262 which in turn instructs the adjustment mechanism 261, such as a motor, to move the backer 260 within the inside of the housing. The adjustment engine 220 can instruct the included processing device 262 to adjust the backer so that the determined quantity of physical objects can fit inside the housing. The backer 260 can be positioned so that the calculated quantity of physical objects can be stored in the housing 240 without leaving empty space between the physical objects and the backer 260. The backer 260 can move along the inside of the housing. As mentioned above, the backer 260 can be positioned between and define the product space and the empty space of the housing 240. The physical objects can be loaded into the product space of the housing 240. In some embodiments, the physical objects can be loaded manually into the housing 240, in response to the backer 260 being adjusted to the correct position. In other embodiments, a separate loading mechanism (not shown) can automatically load the determined quantity of physical objects inside the interior cavity of the housing 240. In some embodiments, the computing device 200 can transmit a command to adjust the temperature of the housing 240 based on the set of attributes associated with the physical object. In some embodiments, the computing device 200 can transmit a command to the included processing device 262 to generate a label on the housing 240 needed for delivery to the facility. The housing 240, including the physical objects loaded in the housing, can be delivered to the facility. In some embodiments, the computing device 200 and the housing 240 can be disposed in the same location. Alternatively, the computing device 200 and the housing 240 can be disposed in separate locations.

As a non-limiting example, the configurable product housing system 250 can be implemented in a warehouse facility to handle fulfillment requests from a retail store. For example, a retail store can request a warehouse facility fulfill a request for a product. A computing device 200 may receive a request to determine a quantity of products to load into a housing 240, for delivery to the retail store. The request can include an identifier associated with the products. The computing device 200 may execute the adjustment engine 220 in response to receiving the request. The adjustment engine 220 can query the physical objects database 225 using the identifier to retrieve a set of attributes associated with the products. The set of attributes can include, a shape of products, a size of products, a demand for products at a facility, a rate of sale of the products at the retail store, past sales of the products over a predetermined amount of time and a quantity of products sent to the retail store in the past. In some embodiments, the products can be perishable items such as fruit or vegetables. Accordingly, the set of attributes can include, the amount of time the perishable items remain fresh, an ideal temperature for the perishable items and any other conditions related attributes. The adjustment engine 220 can determine the quantity of products which need to be loaded into the housing 240 based on the retrieved attributes. The quantity of products determined by the adjustment engine 220 can be an optimal amount of products to be disposed at the retail store so that the least amount of products are wasted while not producing a shortage of the products. In response to determining the quantity of products to be loaded into the housing 240, the adjustment engine 220 can transmit a command to adjust the position of the backer 260 within the housing 240, by instructing the included processing device 262 to move the backer 260 within the inside of the housing, via the motor or other adjustment mechanism 261. The adjustment engine 220 can instruct the included processing device 262 to adjust the backer 260 so that the determined quantity of physical objects can fit inside the housing. The backer 260 can be positioned so that the calculated quantity of physical objects can be stored in the housing 240 without leaving empty space between the physical objects and the backer 260. In one embodiment, the backer 260 can slide forward or backward along the inside housing. The backer 260 can be positioned between the product space and the empty space of the housing 240. The products can be loaded into the product space of the housing 240. In some embodiments, the products can be loaded manually into the interior cavity of the housing 240, in response to the backer 260 being adjusted to the correct position in the interior cavity of the housing 240. In other embodiments, a separate loading mechanism (not shown) can automatically load the determined quantity of products inside the interior cavity of the housing 240, in response to the backer 260 being positioned at the correct position in the interior cavity. In some embodiments, the computing device 200 can adjust the temperature of the housing 240 based on the set of attributes associated with the products. In some embodiments, the computing device 200 can transmit a command to the included processing device 262 to label the housing for delivery to the facility. In some embodiments, the computing device 200 and the housing 240 can be disposed in the same location. Alternatively, the computing device 200 and the housing 240 can be disposed in separate locations.

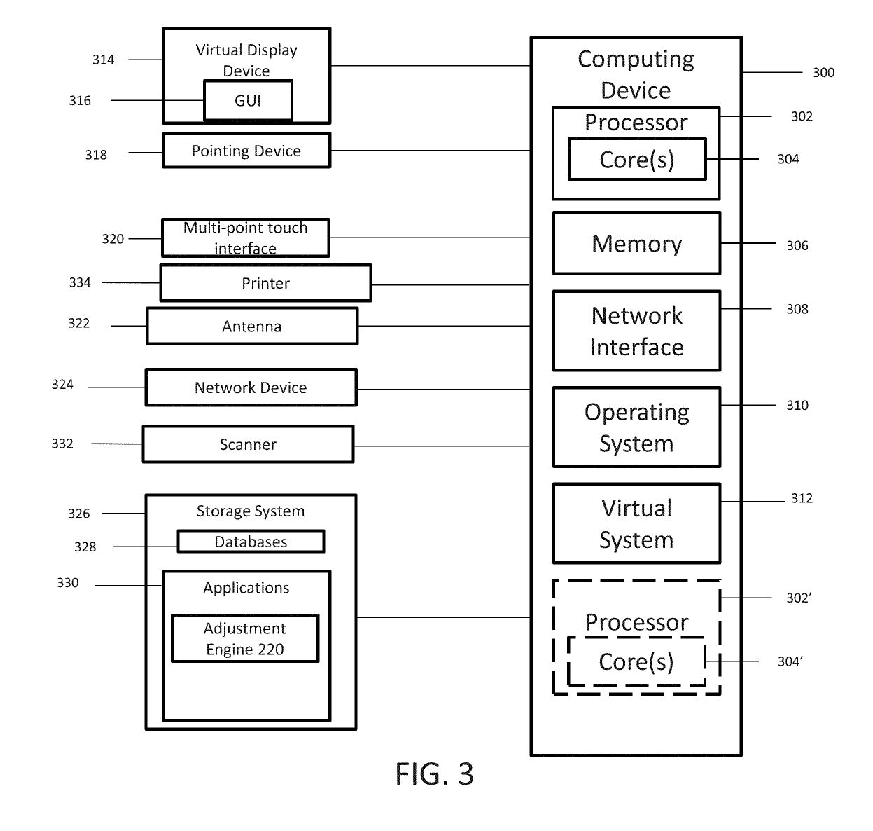

FIG. 3 is a block diagram of an example computing device suitable for use in implementing an exemplary embodiment. Embodiments of the computing device 300 can execute the adjustment engine 220. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 314, such as a computer monitor, which may display one or more graphical user interfaces 316, multi touch interface 320, a scanner 332, a printer 334 and a pointing device 318.

The computing device 300 may also include one or more storage devices 326, such as a hard-drive, CD-ROM, or other computer readable media, for storing data and computer-readable instructions and/or software used in exemplary embodiments (e.g., applications and data). For example, exemplary storage device 326 can include one or more databases 328 for storing information regarding the physical objects. The databases 328 may be updated manually or automatically at any suitable time to add, delete, and/or update one or more data items in the databases. The databases 328 can include information such as physical objects database 225. The physical objects database 225 can store information regarding physical objects.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run operating system 310, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

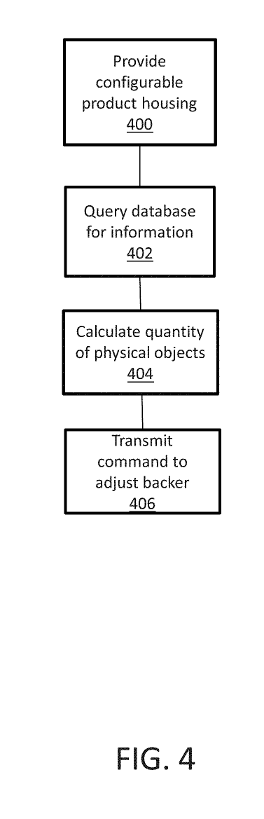

FIG. 4 is a flowchart illustrating an exemplary process implemented by a configurable product housing system according to an exemplary embodiment. The exemplary process begins with a configurable product housing being provided (operation 400). The housing can be configured to store various amounts of physical objects limited by a backer (e.g. backer 130, 138, 144 and 260 as shown in FIGS. 1B-C and 2). The backer can be positioned within the housing and can move forward and backward along the interior cavity (e.g. interior cavity 124 as shown in FIG. 1B) of the housing. The backer can include a processor to control a motor to move the backer forward and backward. The computing device 200 can execute a adjustment engine (e.g. adjustment engine 220 as shown in FIG. 2). In operation 402, the adjustment engine can query the physical objects database to retrieve a set of attributes associated with the physical object. The set of attributes can include, a size of a physical object, the shape of the physical object and/or the a quantity of physical objects sent to the facility in the past. The physical objects can be perishable items. In the event the physical objects are perishable items the set of attributes can include the temperature at which the perishable items stay fresh, the amount of time the perishable items stay fresh and/or other environmental conditions associated with the perishable items. In operation 404, the adjustment engine can calculate the quantity of physical objects to be loaded into the housing based on the retrieved set of attributes. In operation 406, the adjustment engine can instruct the included processing device 262 of the housing to adjust the position of the backer within the interior cavity of the housing based on the calculated quantity of physical objects to be loaded into the housing. The backer can be positioned so that the calculated quantity of physical objects can be stored in the housing without leaving empty space between the physical objects and the backer. The physical objects can be loaded into the interior cavity of the housing after the adjustment of the backing position. In some embodiments, the physical objects can be manually loaded into the interior cavity of the housing. In other embodiments, the physical objects can be loaded, via a loading mechanism.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present invention. Further still, other aspects, functions and advantages are also within the scope of the present invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A configurable product housing system comprising:
a housing equipped with an included processing device and further including a back wall, opposing side walls, and a base defining an interior cavity accessible via an open front face of the housing, the housing configured to store a plurality of physical objects within the interior cavity, the included processing device including a processor and a communication capability;
a backer positioned in front of the back wall in the interior cavity, the backer extending from the base;
an adjustment mechanism mechanically coupled to the backer and configured to adjust a position of the backer within the interior cavity, the adjustment mechanism controllable by the included processing device;
a database holding information about the plurality of physical objects; and
a computing device in communication with the database and the included processing device, the computing device configured to:
query the database to retrieve a set of attributes associated with the plurality of physical objects;
calculate a quantity of physical objects to be loaded into the interior cavity of the housing based on the set of attributes; and
transmit a command to the included processing device to adjust the position of the backer within the interior cavity based on the calculated quantity of physical objects;
wherein the calculated quantity of physical objects is loaded into the interior cavity of the housing.

2. The configurable product housing system of claim 1, wherein the set of attributes can be on or more of a calculated demand for the physical objects in a facility, a quantity of available physical objects and a size of the physical objects.

3. The configurable product housing system of claim 1, wherein the backer is configured to limit the amount of space available in the interior cavity when adjusted to a forward position within the housing.

4. The configurable product housing system of claim 1, wherein the physical objects are perishable objects.

5. The configurable product housing system of claim 1, wherein the interior cavity is temperature controlled.

6. The configurable product housing system of claim 1, wherein the housing includes a top wall and an image related to the plurality of products is displayed on the top wall.

7. The configurable product housing system of claim 1, wherein the included processing device is configured to transmit a command to label the housing for delivery to a facility in response to loading the physical objects.

8. The configurable product housing system of claim 1, wherein the housing is configured to be disposed in a shelving unit in the facility.

9. The configurable product housing system of claim 1, wherein the housing includes a top wall and the backer restricts the view of the interior cavity between the backer and the back wall.

10. A loading method for a configurable product housing, the method comprising:
providing a housing equipped with an included processing device and further including a back wall, opposing side walls, and a base defining an interior cavity accessible via an open front face of the housing, a backer extending from the base and positioned in front of the back wall in the interior cavity, the include processing device including a processor and a communication capability, the backer configured to be adjustable within the interior cavity;
querying, via a computing device in communication with the included processing device, a database to retrieve a set of attributes associated with a plurality of physical objects;
calculating, with the computing device, a quantity of the plurality of physical objects to be loaded into the interior cavity of the housing based on the set of attributes; and
transmitting a command to the included processing device to adjust the position of the backer based on the calculated quantity of physical objects;
wherein the position of the backer is adjusted by an adjustment mechanism controlled by the included processing device and the calculated quantity of physical objects is loaded into the interior cavity of the housing.

11. The method of claim 10, wherein the set of attributes can be one or more of a calculated demand for the plurality of physical objects in a facility, a quantity of available physical objects and a size of the physical objects.

12. The method of claim 10, wherein the backer is configured to limit the amount of space available in the interior cavity when adjusted to a forward position within the housing.

13. The method of claim 10, wherein the physical objects are perishable objects.

14. The method of claim 10, wherein the interior cavity is temperature controlled.

15. The method of claim 10, wherein the housing includes a top wall and an image related to the plurality of products is displayed on the top wall.

16. The method of claim 10, further comprising:
labeling, via the included processing device, the housing for delivery to a facility in response to loading the physical objects.

17. The method of claim 10, wherein housing is configured to be disposed in a shelving unit in the facility.

18. The method of claim 17, wherein the housing includes a top wall and the backer restricts the view of the interior cavity between the backer and the back wall.

19. A configurable product housing system comprising:
a housing equipped with an included processing device and disposed in a shelving unit located in a facility, the housing further including a top wall, an adjustable back wall, opposing side walls, and a base defining an interior cavity accessible via an open front face of the housing, the interior cavity configured to store a plurality of physical objects;
an adjustment mechanism mechanically coupled to the adjustable back wall and configured to adjust a position of the back wall within the housing, the adjustment mechanism controllable by the included processing device;
a database holding information about the plurality of physical objects; and
a computing device equipped with a processor, in communication with the included processing device and a database, the computing device configured to:
query the database to retrieve a set of attributes associated with the plurality of physical objects;
calculate a quantity of physical objects to be loaded into the interior cavity of the housing based on the set of attributes; and
transmit a command to the included processing device to adjust the position of the adjustable back wall within the housing based on the calculated quantity of physical objects;
wherein the calculated quantity of physical objects is loaded into the interior cavity of the housing.
